(19) United States
(12) Patent Application Publication
(10) Pub. No.: US 2007/0154045 A1
(43) Pub. Date: Jul. 5, 2007

(54) DIRECTING A MICROPHONE TOWARD A VEHICLE OCCUPANT

(76) Inventor: Otman A. Basir, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 11/617,958

(22) Filed: Dec. 29, 2006

Related U.S. Application Data
(60) Provisional application No. 60/754,845, filed on Dec. 29, 2005.

(51) Int. Cl. H04B 1/00; B60R 21/16

(52) U.S. Cl. 381/365; 280/735; 381/86

(57) ABSTRACT

An example method for positioning a microphone includes determining the position of an occupant in a passenger compartment of a vehicle. The example method directs the microphone towards the position. Another example method for positioning a microphone includes generating at least one electric signal corresponding to at least one measurement and determining a position of an occupant in the passenger compartment of a vehicle using the at least one electric signal. The method adjusts at least one microphone based on the position.

This application claims priority to U.S. Provisional Application Ser. No. 60/754,845 filed Dec. 29, 2005.

### BACKGROUND OF THE INVENTION

This invention relates to a vehicle occupant position sensor system. More particularly, this invention relates to a vehicle occupant position system that provides occupant position information to a directional microphone and additionally may provide occupant position information to a vehicle occupant safety system.

Many vehicles include in-vehicle communication systems, such as a cell phone connection systems and voice driven navigational systems. These systems may work with the vehicle's sound system to provide the driver with hands free communication capability while in the vehicle. Many such communication systems must detect audible information from the driver (or another user within the vehicle). One or more microphones fixed in a position that focuses on the expected area of a driver's head detect the audible information. Provided the driver's head is in the expected area, focusing the fixed microphone on the expected area reduces undesirable outside noise and facilitates retrieving a quality sound signal from the driver. That is, focusing the microphone on the source of desired sound (in this case the driver) reduces picking up undesirable noise.

Since the position of the driver fluctuates depending on, for example, the driver's height and seated position, fixed microphones cannot focus on too small an area. That is, relative to the fixed microphones, the position of the driver's head may move between a range of heights and distances. According, the fixed microphone must balance receiving a quality sound signal with accommodating different driver positions.

Current vehicle occupant safety system designs attempt to minimize occupant injuries during a vehicle crash. Sensing a crash and activating such a safety system in response to the crash is known. Some occupant protection systems further sense the position of an occupant with respect to inflatable protection modules (i.e., airbags) using designated occupant position sensors, which add cost and complexity to the occupant protection system. The occupant protection system may adjust deployment aspects of the airbags in response to the sensed position of the occupant. It is desirable, in some examples, to suppress actuation of an airbag if deploying the airbag will not enhance protection of the occupant, such as when the occupant is located very near the undeployed airbag.

### SUMMARY OF THE INVENTION

An example method for positioning a microphone includes determining the position of an occupant in a passenger compartment of a vehicle. The example method directs the microphone toward the position.

Another example method for positioning a microphone includes generating at least one signal corresponding to at least one measurement and determining a position of an occupant in the passenger compartment of a vehicle using the at least one signal. The method adjusts at least one microphone based on the position. The example method may include adjusting a function of an occupant safety system based on the position, such as deployment of an airbag.

These and other features of the present invention can be best understood from the following specification and drawings, the following of which is a brief description.

### BRIEF DESCRIPTION OF THE DRAWINGS

FIG. 1 illustrates an example vehicle occupant proximity sensor system installed in a vehicle connected to an occupant safety system and a vehicle communication system.

FIG. 2 is a schematic representation of an example procedure for determining the distance from the head of the occupant to the headliner.

### DETAILED DESCRIPTION OF A PREFERRED EMBODIMENT

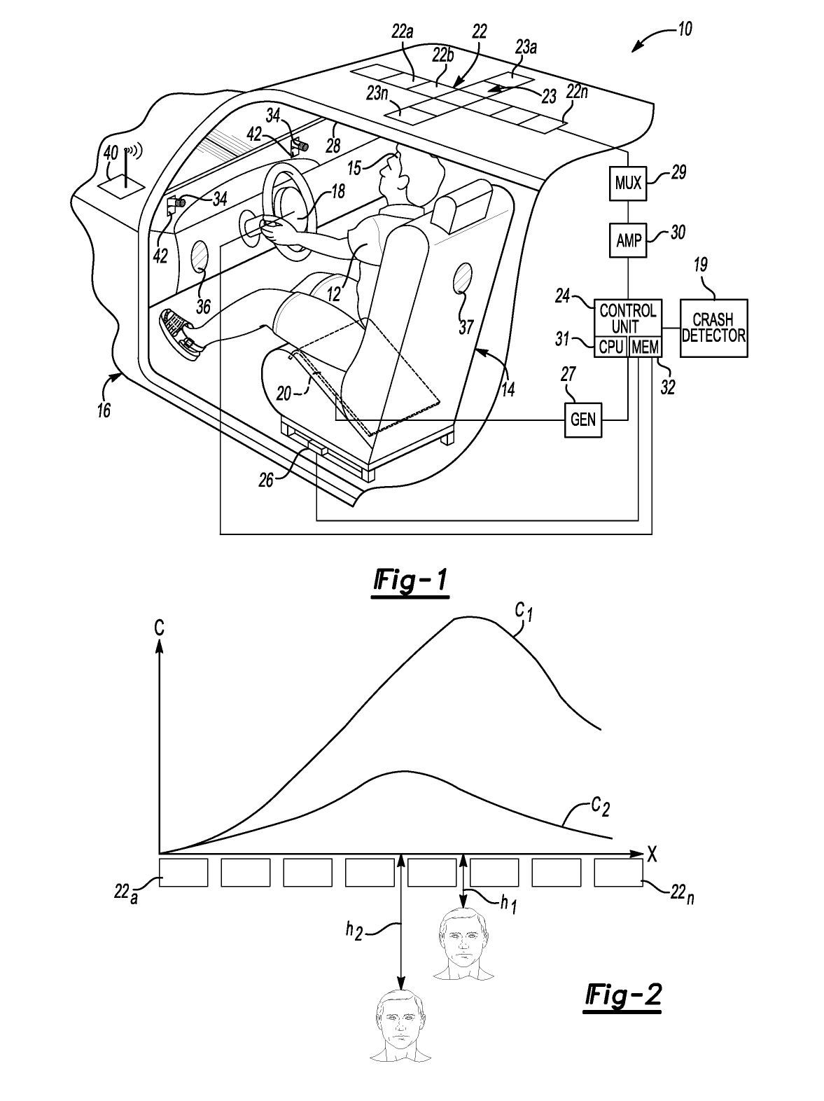

An example vehicle occupant proximity sensor system 10 determines the position of an occupant 12 seated in a vehicle seat 14, and located inside a vehicle passenger compartment 16, as shown in FIG. 1. More particularly, the proximity sensor system 10 determines the position of the occupant's head 15 relative to fixed areas of the vehicle passenger compartment 16.

The occupant 12 may access an in-vehicle communication system that includes two directionally-controlled microphones 34, speakers 36 and 37, and a wireless transceiver 40, such as a cell phone transceiver. An airbag 18, a type of automatic safety restraint, may form a portion of an overall occupant safety system.

The proximity sensor system 10 determines the three-dimensional position of the occupant's head 15 within the passenger compartment 16. The proximity sensor system 10 may comprise any suitable sensor or combination of sensors. For example, optical sensors, cameras, infrared sensors, electromagnetic sensors, capacitance sensors, lasers, etc. may be used. The example proximity sensor system 10 uses capacitance based sensors.

A control unit 24 of the example proximity sensor system 10 includes a CPU 31 with storage 32, such as RAM, ROM, DVD, CD, a hard drive, or other electronic, optical, magnetic medium. Of course, the control unit 24 may use any computer readable medium capable of storing programs for performing the steps and algorithms described herein. The CPU 31 is suitably programmed to perform the function of the example proximity sensor system 10. A person of ordinary skill in the art, with the benefit of this disclosure, could suitably program the CPU 31 or supply any additional needed hardware, or both.

If the head 15 position of the occupant 12 is known, the control unit 24 sends a signal to one or more microphone controllers 42, which direct their associated microphones 34 toward the head 15. The microphone controller 42 may be a servo-motor that physically rotates each microphone 34, moves each microphone 34, or both. Of course, devices other than the servo-motor could be used to physically direct the microphones 34. Alternatively, the microphone controller 42 may use noise cancellation capabilities such as a noise cancelling algorithm, where one or more microphones 34 are combined in such a way so that only sound from a desired location or direction is amplified. In such an example, the algorithm would cause amplified sound from the area of the passenger compartment 16 corresponding to the head 15.

As the occupant 12 moves, the control unit 24 adjusts to a new head 15 position by sending a signal directing the microphones 34 to adjust their respective focus. Continually adjusting the microphones 34 toward the head 15 maximizes the opportunity for detecting a quality signal from the occupant 12.

To properly adjust the microphones 34, the proximity sensor system 10 provides the control unit 24 with the location of the head 15. To calculate the head 15 position, the proximity sensor system 10 includes, in this example, a transmitting electrode 20 generating an electromagnetic signal and a first array 22 of receiving electrodes 22a-n perpendicularly intersecting a second array 23 of receiving electrodes 23a-n. The receiving electrodes 22a-n, 23a-n receive the electromagnetic signal generated by the transmitting electrode 20. The control unit 24 receives electrical signals from the receiving electrodes 22a-n, 23a-n based upon the electromagnetic signal received by the electrodes 22a-n, 23a-n. The control unit 24 may also receive a signal from a seat track position sensor 26 indicating the position of the vehicle seat 14 on a vehicle track (not shown) in the passenger compartment 16.

The transmitting electrode 20 mounts within the base of vehicle seat 14 below the occupant 12. The transmitting electrode 20 may comprise a coil of wire, a copper sheet or conductive paint or thread, and can be made from any conductive material, but preferably comprises a mesh of copper wires approximately one inch apart. Generally, it is preferred to cover a large area of the base of the seat 14 with the transmitting electrode 20 and to wrap the transmitting electrode 20 around the front of the seat 14.

The receiving electrode arrays 22, 23 mount within a headliner 28 above the occupant 12 in the passenger compartment 16. The receiving electrodes 22a-n, 23a-n are connected to the control unit 24 via a multiplexer 29 and an amplifier 30. The multiplexer 29 enables the control unit 24 to sequentially read electric signals from the receiving electrodes 22a-n, 23a-n. In another example, analog-to-digital converters (not shown) may convert the signals from amplifiers 30 to a computer-readable format.

The control unit 24 controls a frequency generator 27 to generate a 10 KHz signal from the transmitting electrode 20, which transmits the signal as an electromagnetic wave inside the vehicle passenger compartment 16. The wave moves from the transmitting electrode 20, through the occupant 12, and to the receiving electrodes 22a-n, 23a-n. The wave moves through the point on the occupant 12 closest to the receiving electrodes 22a-n, 23a-n (i.e., the highest point of the occupant).

The signal received by each receiving electrodes 22a-n, 23a-n fluctuates based on the measured capacitance between the receiving electrodes 22a-n, 23a-n and the transmitting electrode 20. That is, the value of the signal realized by the receiving electrodes 22a-n, 23a-n is a function of the distance between the highest point of the occupant 12 and the respective receiving electrode 22a-n, 23a-n, as shown in FIG. 2. The amplifiers 30 may enhance the individual electric signals moving from the electrode 22a-n, 23a-n to the control unit 24. Size, spacing, and the number of electrodes 22a-n, 23a-n in each of the receiving electrode arrays 22, 23 may vary for different applications and/or vehicle designs.

The control unit 24 controls multiplexer 29 to sequentially read each of the receiving electrodes 22a-n, 23a-n in arrays 22, 23. Although performed sequentially, it is performed sufficiently quickly relative to normal motion of a vehicle occupant 12 to provide what is effectively an instantaneous snapshot of sufficient information to determine the position of the occupant 12 in the passenger compartment 16. The closer the occupant 12 is to a particular receiving electrode 22a-n, 23a-n, the higher the measured capacitance. As the head 15 of the occupant 12 is the closest to the electrode arrays 22, 23, the highest capacitance will be measured at the receiving electrode closest to head 15 of the occupant 12.

The position of the head 15 can be determined in many different ways, using the electrodes 22a-n, 23a-n. For example, the position of the head 15 can be determined by triangulation using distance calculations to several of the electrodes 22a-n, 23a-n. However, this technique may be subject to drift and noise. As an alternative, the three-dimensional position of the head can be determined based upon the shape of the distribution of the signals generated by the electrodes 22a-n, 23a-n. An x-coordinate in FIG. 2 corresponds to the peak value of the capacitance as measured by the respective electrodes 22a-n. Similarly, a y-coordinate corresponds to the peak value of the capacitance as measured by the electrodes 23a-n.

The z-coordinate can be determined based upon the shape of the x and y distributions. Although FIG. 2 illustrates the x-coordinate distribution, the y distribution would be similarly analyzed. When a head 15 is close to the array 22, the distance h₁ from the head 15 to the closest electrode within the array 22 is significantly greater (as a ratio or percentage) than the distance from the head 15 to the other electrodes within the array 22. As a result, the shape of the distribution C₁ is steep. When the head 15 is far from the array 22 of electrodes, the distance h₂ from the head 15 to the closest electrode within the array 22 is less significantly greater (as a ratio or percentage) than the distance from the head 15 to the other electrodes within the array 22, and the resulting shape of the distribution C₂ is therefore flatter. The distributions C₁ and C₂ may drift up or down based upon temperature or other factors, but their shape will remain relatively constant and a reliable indicator of distance. The correlation of the shapes and slopes of the curves to head 15 position in a particular arrangement can be determined experimentally and stored for use in determining position of the head 15 based upon shape of the distributions C1 and C2.

The control unit 24 monitors the information from the receiving electrode array 22 over time. For example, the position of the head 15 of the occupant 12 cannot change instantaneously; it must follow a path from one point to another. The control unit 24 may additionally take information from the vehicle seat track position sensor 26, which indicates the position of the vehicle seat 14 on a vehicle seat track. This information is utilized by control unit 24 to determine the position of the occupant 12.

The position information can then be used to control additional system attached to the control unit 24, such as an occupant safety system including the airbag 18. For example, when the proximity sensor system 10 indicates that the position of the head 15 of the occupant 12 is in a position not suitable for deploying the airbag 18, such as if the head is too near the airbag 18, the control unit 24 prevents the airbag 18 from deploying. Of course, the control unit 24 may utilize information from the vehicle seat track position sensor 26 in addition to the positional information about the head 15.

Although a preferred embodiment of this invention has been disclosed, a worker of ordinary skill in this art would recognize that certain modifications may come within the scope of this invention. For that reason, the following claims should be studied to determine the true scope of legal protection available for this invention.

We claim:

1. A method for positioning a microphone, comprising:
determining a position of an occupant in a passenger compartment of a vehicle; and
directing the microphone toward the position.

2. The method of claim 1, including determining a position of an occupant head.

3. The method of claim 1, including receiving information corresponding to the distance between each of a plurality of occupant position sensors and the occupant.

4. The method of claim 3, using the information corresponding to the distance to determine the position.

5. The method of claim 4, wherein capacitance measured by the plurality of occupant sensors is a type of information corresponding to the distance between each of the plurality of occupant position sensors and the occupant.

6. The method of claim 1, including directing the microphone by changing the location of the microphone using at least one microphone controller.

7. The method of claim 1, including directing the microphone using noise cancellation.

8. The method of claim 7, including directing the microphone by canceling noise away from the position.

9. A method for positioning a microphone, comprising:
generating at least one signal corresponding to at least one measurement;
determining a position of an occupant in a passenger compartment of a vehicle using the at least one signal; and
adjusting at least one microphone based on the position.

10. The method of claim 9, wherein the position is a three-dimensional head position of the occupant.

11. The method of claim 9, wherein an electromagnetic signal having a portion directed through the occupant provides the at least one measurement.

12. The method of claim 9, wherein measuring a signal strength of an electromagnetic signal at a plurality of locations provides the at least one measurement.

13. The method of claim 12, including measuring the signal strength using a plurality of electrodes receiving portions of the electromagnetic signal.

14. The method of claim 13, wherein the plurality of electrodes are arranged in a first array and a second array, said first array substantially transverse to said second array.

15. The method of claim 13, wherein measuring the signal strength includes measuring the capacitance.

16. The method of claim 9, including adjusting a function of an occupant safety system based on the position.

17. The method of claim 16, including disabling a portion of the occupant safety system based on the position.

18. The method of claim 17, wherein the portion is an airbag.

19. An apparatus for directing a microphone toward a vehicle occupant, comprising:
a microphone;
a sensor system for determining a position of an occupant within a vehicle; and
a control unit configured to direct said microphone toward said occupant in response to said position.

20. The apparatus of claim 19, wherein said sensor system includes a transmitting electrode adapted to transmit a first electromagnetic signal at least partially through said occupant

21. The apparatus of claim 20, wherein said sensor system includes a plurality of receiving electrodes each adapted to receive a portion of a first signal and to send a second signal to said control unit in response to said portion of said first signal.

22. The apparatus of claim 21, wherein said first signal, said second signal, or said first and said second signal correspond to a distance between said occupant and at least one of said plurality of receiving electrodes.

23. The apparatus of claim 21, wherein at least one of said plurality of receiving electrodes are adapted to measure a signal strength of said first signal.

24. The apparatus of claim 23, wherein said signal strength includes a capacitance measurement.

25. The apparatus of claim 19, wherein said control unit directs said microphone by controlling a controller to reposition said microphone.

26. The apparatus of claim 19, wherein said control unit directs said microphone using noise cancellation.

27. The apparatus of claim 19, wherein said control unit disables a portion of an occupant safety system based on said position.

28. The apparatus of claim 19, including at least a portion of said transmitting electrode within a vehicle seat.

29. The apparatus of claim 19, wherein at least one of said plurality of receiving electrodes is located within a vehicle headliner.
